(19) United States
(12) Patent Application Publication
(10) Pub. No.: US 2006/0137200 A1
(43) Pub. Date: Jun. 29, 2006

(54) Level holder

(76) Inventors: Joseph Lollar, Hattiesburg, MS (US); Tommy Perryman, Hattiesburg, MS (US)

Correspondence Address: CROSSLEY PATENT LAW, 400 SOUTH THIRD STREET, MONTROSE, CO, 81401, US

(21) Appl. No.: 11/321,018

(22) Filed: Dec. 28, 2005

Related U.S. Application Data
(63) Continuation-in-part of application No. 11/023,118, filed on Dec. 28, 2004, now abandoned.

(51) Int. Cl. G01C 9/00

(52) U.S. Cl. 33/371

(57) ABSTRACT

A basic and easily utilized level holder, the holder comprising a ratcheting swivelly attached improved C-clamp and cage for holding a typical level. The cage comprises cage members that surround a removably inserted level and allow full viewing thereof. The cage further comprises two contrasting planes of horizontal levels for further usefulness. Cage members are further rubber coated or of plastic to guard against marring of a level. The cage bottom and back are preferably porous for allowing escape of construction particles, liquids, and the like.

Be it known that we, Tommy C. Perryman and Joseph Lollar, citizens of the United States, have invented new and useful improvements in a level holder as described in this specification. This application is a continuation in part of prior U.S. patent application Ser. No. 11/023,118 filed Dec. 28, 2004.

### BACKGROUND OF THE INVENTION

In building, structural repair, and the like, orientation of components is not only important but often critical. Establishing vertical, horizontal, and planar positions is necessary in most cases. While laser levels are now often used in various applications, there remains no substitute for the bubble level. With a slightly convex shape, the vial of the bubble level is nearly filled with liquid, the remaining air space provides for a bubble to travel from end to end of the vial, thereby indicating conditions of level. Bubble vials are of use in various planes. The present invention offers a basic design for using a typical bubble level such as the extended length levels most widely recognized. The invention also features additional orientation bubble levels as a part of its makeup, for further clarification and orientation in positioning.

1. Field of the Invention

This invention pertains to a level holder for releasably holding a removable level to a work member or surface.

2. Description of the Prior Art

In the course of building virtually any sort of structure, whether of wood, pipe, or other materials, components must often be checked for level. While the prior art has no shortages of means for accomplishing such tasks, it does not disclose a device like the present invention. By way of example, U.S. Pat. No. 5,402,579 to Smith discloses a C-clamp with an integral level and is therefore unlike the present invention. The invention is not a level holder.

U.S. Pat. No. 4,066,232 to Hermeyer discloses a shell affixed to a spring clamp. While the device is useful for its intended purpose, it does not offer the security of the present invention's clamp, nor the benefit of wide jaws, as does the present invention, for securing to a variety of surfaces.

U.S. Pat. No. 5,819,425 to Payne discloses a complex device for attaching a level to a construction component. While the device is no doubt useful, it does not offer the basic design and easy-to-use platform of the present invention. Further, the Payne device distinctly points out and claims the specificity of use in the claim preamble, “a clamp for temporarily holding a level against an elongated construction element having a straight edge to be predeterminedly oriented . . . ” As such, the device is relegated to holding against a straight edge, which is further dictated by the design of the device. The specificity of the device greatly differs from the current invention.

U.S. Pat. No. 5,477,997 to Weatherly discloses a device for carrying bricks worn by a bricklayer. Specifically, the device is a belt with a compartment designed to hold the weight of a plurality of bricks. The device is not meant for attachment to work, as is the present invention, and is quite dissimilar in form and function. The device preamble distinctly claims “a device for carrying brick, said device comprising: a belt, a harness attached to the belt, a holder attached to said belt and having an inner surface . . . dimensioned to hold said bricks, said holder having means formed therein for spacing said bricks apart from said inner surface of said holder” The dimensions needed for holding and spacing bricks are far different for those needed in holding a level.

U.S. Pat. No. 4,171,800 by Weaver discloses a work holder assembly for retaining jewelry articles. The device further includes ring assembly connected to the bench mount. The objects of the invention are listed specifically to jewelry work pursuits the preamble of the claims distinctly points out “a work holder for retaining a jewelry article”. There exists no motivation either stated or implied to transfer the knowledge, practices, or tools from a jeweler's pursuits to those of a tradesman in working with a level or levels.

While the above-described devices fulfill their respective and particular objects and requirements, they do not describe a level holder that provides for the advantages of the present invention; therefore, a need exists for an improved level holder, particularly one that includes a very basic design, quickly adapted to a component for clamping thereon, while at the same time fitting virtually any typical level. In this respect, the present invention substantially departs from the conventional concepts and designs of the prior art.

### SUMMARY OF THE INVENTION

In view of the foregoing disadvantages inherent in the known types of level holders now present in the prior art, the improved level holder overcomes the above-mentioned disadvantages and drawbacks or the prior art.

As such, the general purpose of the level holder, described subsequently in greater detail, is to provide a level holder which has all of the advantages of the prior art mentioned heretofore and many novel features that result in an improved level holder which is not anticipated, rendered obvious, suggested, or even implied by the prior art, either alone or in combination thereof.

To accomplish this, the present improved level holder comprises a C-clamp bonded by welding or a pivot to a cage for holding a typical level. The cage is comprised of a base plate, a case back attached to horizontal u-shaped cage members, the members joined by vertical cage member uprights to the base plate. One example of the C-clamp, without pivot capabilities, is further bonded to two additional support arms, which are also bonded to the level cage, to insure durability and strength. The invention is offered with more than one size of C-clamp so that various uses are possible, in either small or large applications. The typical C-clamp of the invention invites immediate understanding and use by virtually anyone. The open cage provides for level visibility, and the cage members are rubber coated for protecting a level. Preferably, the cage is about 5 inches high so that the level is securely held. And, the cage is about 2¾ inches wide and about 1½ inches deep. These specific dimensions are most useful in properly holding a typical elongated level. When not in use, the level holder offers secure storage of a level. Further, the base plate and case back of the invention is preferably porous such that particles and liquids are allowed to pass through, a feature often needed in the work environments for which the present invention is designed.

With the needs in use of the level holder, further features add to the present invention's uniqueness. The front of the base plate includes a small bubble level. Additionally, the side of the base plate also includes a small bubble level. The ability to orient leveling of the invention from these two planar positions provides even further usefulness, beyond that of holding a larger level, which is often needed in more exact determinations and even in initially properly locating the level holder. These features of multifaceted advantages offer functions otherwise not available in the art.

In yet another example, the attachment of the cage to the C-clamp's vertical member is via a swivel, such that the cage can be rotated with respect to the clamp. While the preferred example of the level holder comprises metal construction, other suitable materials such as alloys and plastics are used in other examples. Additionally, the swivel is equipped with a ratcheting mechanism. The ratcheting mechanism is like those used in mechanical ratchets known in the tool arts. The ratcheting mechanism is reversible and is equipped with fine teeth such that small positional movements of the swivel are retained. Reversal of ratcheting is accomplished by the slight rotation of the cross handle, as is also typical in ratcheting tools.

Thus has been broadly outlined the more important features of the level holder so that the detailed description thereof that follows may be better understood and in order that the present contribution to the art may be better appreciated.

Numerous objects, features and advantages of the level holder will be readily apparent to those of ordinary skill in the art upon reading the following detailed description of presently preferred, but nonetheless illustrative, examples of the level holder when taken in conjunction with the accompanying drawings. In this respect, before explaining the current examples of the level holder in detail, it is to be understood that the invention is not limited in its application to the details of construction and arrangements of the components set forth in the following description or illustration. The invention is capable of other examples and of being practiced and carried out in various ways. It is also to be understood that the phraseology and terminology employed herein are for purposes of description and should not be regarded as limiting.

Those skilled in the art will appreciate that the conception upon which this disclosure is based may readily be utilized as a basis for the design of other structures, methods and systems for carrying out the several purposes of the level holder. It is therefore important that the claims be regarded as including such equivalent constructions insofar as they do not depart from the spirit and scope of the present invention.

A primary object, then, of the level holder is basic design.

An added object of the level holder is to hold a typical level and be easily engaged or disengaged from a varied plurality of supports or work pieces.

Still another object is to provide a level holder that can be inexpensively manufactured.

A further object of the level holder is to offer multiple leveling devices within the unit itself.

And, it is an object of the level holder to provide a ratcheting swivel for further adjustment in level holding.

These together with additional objects of the level holder, along with various novel features that characterize the invention are particularly pointed out in the claims forming a part of this disclosure. For better understanding of the level holder, its operating advantages and specific objects attained by its uses, refer to the accompanying drawings and description.

### BRIEF DESCRIPTION OF THE DRAWINGS

FIG. 1 is a perspective view clamped to a support, with a typical level inserted.

FIG. 2 is a perspective view illustrating the front level and the side level on the base plate.

FIG. 3 is a cross sectional view of FIG. 2, the example of the invention with the left and right support arms supporting the case back to the C-clamp.

FIG. 4 is a side elevation of FIG. 2.

FIG. 5 is a side elevation illustrating the swivel of the preferred example.

FIG. 6 is a top view of the ratcheting mechanism and cross handle of the preferred example with the swivel.

### DETAILED DESCRIPTION OF THE DRAWINGS

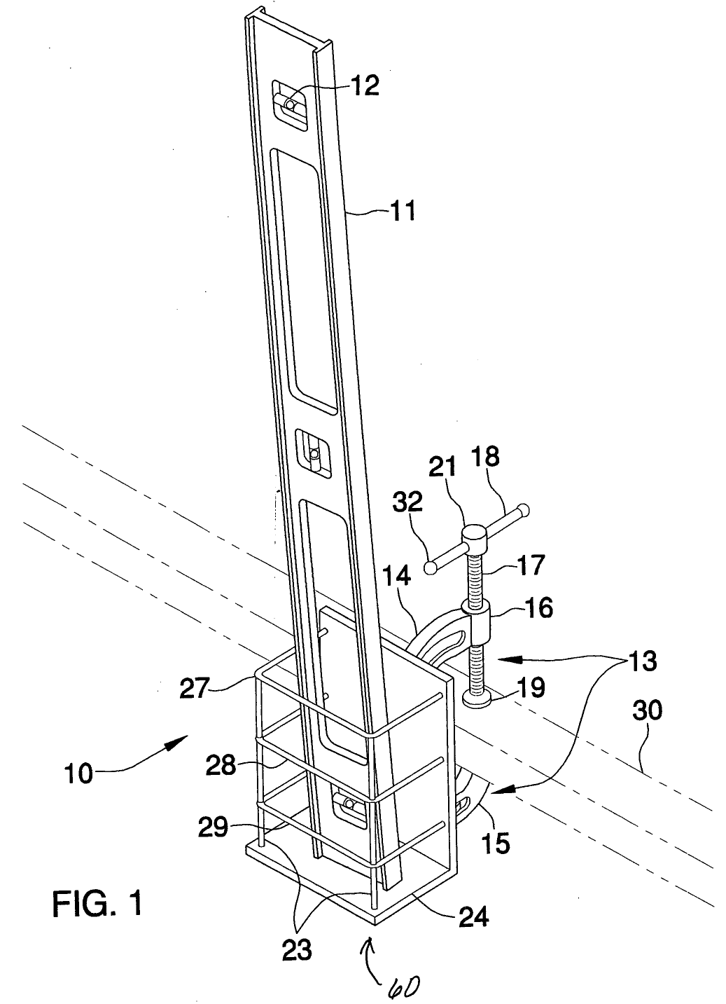

With reference now to the drawings, and in particular FIGS. 1 through 6 thereof, the preferred examples of the level holder employing the principles and concepts of the present invention and generally designated by the reference number 10 will be described.

Referring to FIG. 1, level holder 10 is clamped to a typical support 30. Level holder 10 removably holds a typical level 11 in an upright position, with typical bubble tube 12 revealing a level horizontal status. T-handle 18 has been used to tighten upper planar surface 19 against support 30. C-clamp 13 of invention 10 is thereby secured to support 30. Level 11 rests upon base plate 24 and is supportively surrounded by top cage member 27, center cage member 28 and lower cage member 29.

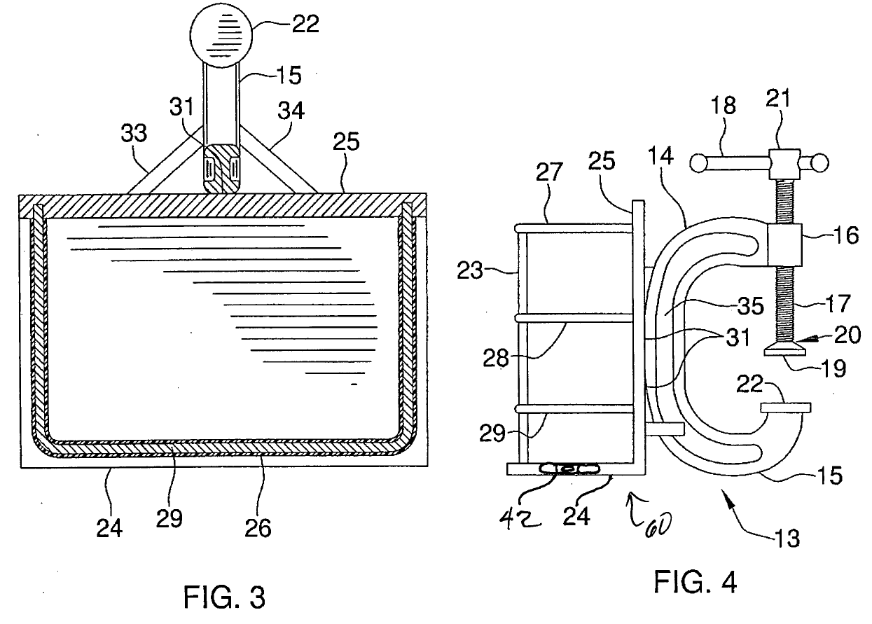

Cage members 27, 28, and 29 project a horizontal u-shape that both begins at first end and attaches again at second end to case back 25. Cage members 27, 28, and 29 are further supported by vertical cage members 23 at the respective corner bends of members 27, 28, and 29. At lower extremity, vertical cage members 23 are permanently attached to cage base plate 24. Members 23, 27, 28, and 29, base plate 24, and case back 25 form a cage 60 for removably containing level 11 and are finished with rubber coating 26 (FIG. 3) to prevent scratching or damage to level 11. The specific internal dimensions of the cage 60 are sized to hold a level 11 in a variety of positions.

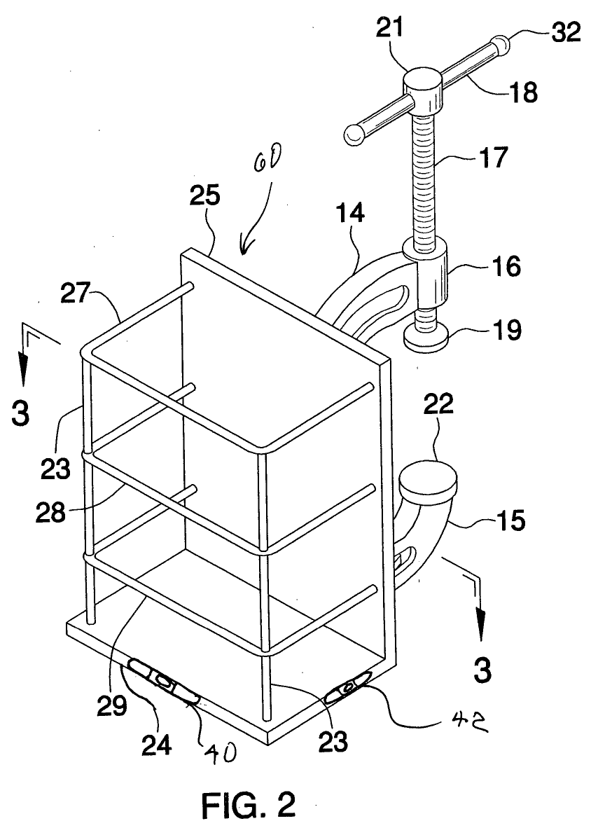

Referring to FIG. 2, the front level 40 and the side level 42 are positioned on the base plate 24. The front level 40 is disposed on the front of the base plate 24. The side level 42 is disposed on the side of the base plate 24. The front level 40 and the side level 42 offer quick references to set up of the invention 10 as needed, as well as further reference of positioning beyond that offered by the level being held. The invention 10 can be used as a leveling tool even without the addition of the level being held by the invention 10. While an extended length level, such as one being held, is usually superior in accuracy, the added benefits of the included front level 40 and side level 42 cannot be negated.

Referring now to FIGS. 3 and 4 of a varied example of the invention 10, the typically formed C-clamp 13 is affixed to case back 25 by attachment weld 31. Strong attachment is further guaranteed by welding left support arm 33 and right support arm 34 to C-clamp 13 and to case back 25. (FIG. 3)

Vertical portion 35 of C-clamp 13 is fixed perpendicularly to back 25. From vertical portion 35, C-clamp 13 extends both downward to lower horizontal portion 15 and upward to upper horizontal portion 14. From portion 15, C-clamp 13 terminates at lower planar surface 22. From upper horizontal portion 14 C-clamp 13 extends into threaded aperture 16 for receiving threaded rod 17. Rod 17 is upwardly bounded by handle receiver 21 and T-handle 18. Handle 18 slideably resides within receiver 21 and is captured from escape by handle knobs 32 on either end. At lower end of rod 17 is upper planar surface 19 held to rod 17 by rod swivel 20. Rod swivel 20 allows use of invention 10 on an imperfect surface (not shown). Using T-handle 18 to rotate threaded rod 17 within threaded aperture 16 causes upper planar surface 19 to approach lower planar surface 22. As shown in FIG. 1, invention 10 thereby firmly engages support 30. Reverse turn (counterclockwise) of T-handle 18 disengages upper planar surface 19 and lower planar surface 22 from support 30. By providing a secure cage for a typical level 11, a worker (not shown) can verify angles of construction and assembly. Further, the level holder 10 is used to store a level when not in use.

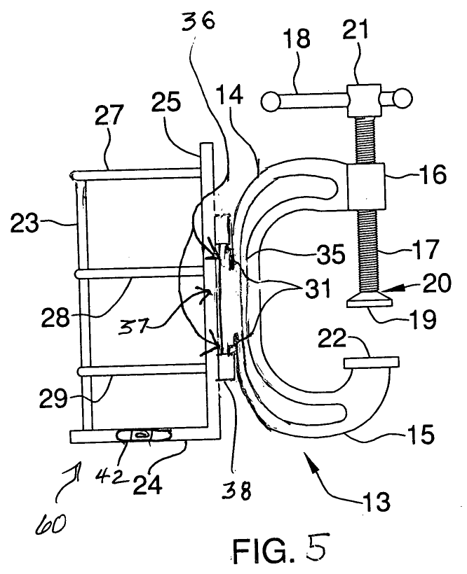

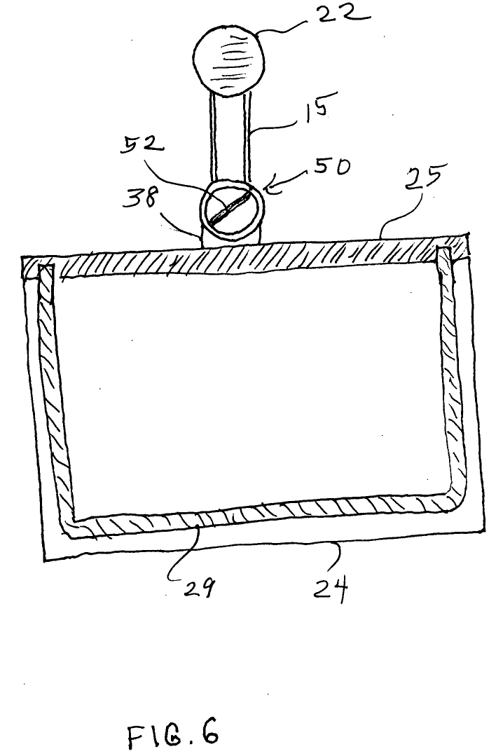

Referring to FIG. 5, the preferred example of the invention 10 includes the swivel 37 which joins the case back 25 to the C-clamp 13. The attachment welds 31 secure each swivel post 36 to the vertical portion 35 of the C-clamp 13. Each swivel post 36 fits within a receiver 38. The top receiver 38 further comprises a ratchet 50 (FIG. 6). The ratchet mechanism 50 is known in the art of tools.

The ratchet 50 provides for selectively secured adjustment of the swivel 37 positioning, the cage 60 thereby pivoted in relation to the C-clamp 13. The swivel 37 between the case back 25 and the C-clamp 13 allows the case back 25 to pivot about the C-clamp 13. The reversible ratchet 50 mechanism is disposed within the swivel 37 at the top end, whereby the relative pivotal position of the case back 25 to the C-clamp 13 is selectively held. The ratchet 50 is reversible via the cross handle 52 in the top of the ratchet 50. Partially turning the cross handle 52 in one direction or the other selects the locking either right to left of the ratchet 50, as is further typical of ratcheting tools.

While basic in nature, the present invention 10 offers a multitude of potential attachments and attachment angles to virtually any work related device or component, while at the same time offering level indication in a variety of planes, via the built in front level 40 and side level 42 as well as the selectively inserted level 11. The ratcheting swivel 37 offers tuning the present invention 10 usefulness even further.

With respect to the above description then, it is to be realized that the optimum dimensional relationships for the parts of the level holder, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A level holder comprising a C-clamp with cage for holding a typical level, the cage sized to accommodate the level, the cage comprising:
a case back having a front side and a back side;
a base plate perpendicularly attached to a bottom of the case back;
a plurality of cage members attached to the base plate and the front of the case back, the cage members for surrounding the level;
a bubble level disposed upon a front of the base plate;
a bubble level disposed upon a side of the base plate;
the level holder further comprising:
a C-clamp perpendicularly attached to the back side of the case back, the clamp for holding the cage in position for removably receiving the level;
a left support arm and a right support arm attaching the C-clamp to the case back, for further rigidity;

2. The invention in claim 1 wherein the C-clamp comprises:
a vertical portion welded to the case back;
a lower horizontal portion emanating from the vertical portion, the lower horizontal portion terminating in a lower planar surface, the lower planar surface for contacting a surface of a chosen support;
an upper horizontal portion emanating from the vertical portion, the upper horizontal portion terminating in a threaded aperture;
a threaded rod inserted within the threaded aperture, the threaded rod having an upper planar surface for contacting a surface of the chosen support, opposite that of the lower planar surface;
a rod swivel between the upper planar surface and the threaded rod, the rod swivel providing for use of the C-clamp on an imperfect surface;
a handle receiver at an upper boundary of the threaded rod;
a T-handle slideably engaged within the handle receiver, the T-handle for rotating the threaded rod, thereby causing tightening and loosening of the planar surfaces about the chosen support.

3. The invention in claim 1 wherein the cage members are rubber coated.

4. The invention in claim 2 wherein the cage members are rubber coated.

5. The invention in claim 1 wherein the base plate is porous;

6. The invention in claim 2 wherein the case back is porous.

7. The invention in claim 3 wherein the case back is porous.

8. A level holder comprising a C-clamp with cage for holding a typical level, the cage sized to accommodate the level, the cage comprising:
a case back having a front side and a back side;
a base plate perpendicularly attached to the case back;
a plurality of cage members attached to the base plate and the front side of the case back, the cage members for surrounding the level;
a bubble level disposed upon a front of the base plate;
a bubble level disposed upon a side of the base plate;
the level holder further comprising:
a swivel disposed between the case back and the C-clamp whereby the case back can pivot about the C-clamp;
the C-clamp attached to a side of the swivel, the C-clamp attached at a vertical portion of the C-clamp;
the back side of the case back attached to a side of the swivel opposite the C-clamp;
a lower horizontal portion of the C-clamp emanating from the vertical portion of the C-clamp, the lower horizontal portion terminating in a lower planar surface, the lower planar surface for contacting a surface of a chosen support;
an upper horizontal portion of the C-clamp emanating from the upper horizontal portion of the C-clamp, the upper horizontal portion terminating in a threaded aperture,;
a threaded rod inserted within the aperture, the threaded rod having an upper planar surface for contacting a surface of the chosen support opposite that of the lower planar surface;
a rod swivel between the upper planar surface and the threaded rod, the rod swivel providing for use of the C-clamp on an imperfect surface;
a handle receiver at an upper boundary of the threaded rod;
a T-handle slideably engaged within a handle receiver, the T-handle for rotating the threaded rod, thereby causing tightening and loosening of the planar surfaces about the chosen support.

9. The invention in claim 8 wherein the cage members are rubber coated.

10. The invention in claim 8 wherein the base plate is porous.

11. The invention in claim 9 wherein the base plate is porous.

12. The invention in claim 10 wherein the case back is porous.

13. The invention in claim 11 wherein the case pack is porous.

14. The invention in claim 9 wherein the cage is about 5 inches high, 2¾ inches wide, and 1½ inches deep.

15. The invention in claim 10 wherein the cage is about 5 inches high, 2¾ inches wide, and 1½ inches deep.

16. The invention in claim 12 wherein the cage is about 5 inches high, 2¾ inches wide, and 1½ inches deep.

17. A level holder comprising a C-clamp with cage for holding a typical level, the cage sized to accommodate the level, the cage comprising:
a case back having a front side and a back side;
a base plate perpendicularly attached to the case back;
a plurality of cage members attached to the base plate and the front side of the case back, the cage members for surrounding the level;
a bubble level disposed upon a front of the base plate;
a bubble level disposed upon a side of the base plate;
the level holder further comprising:
a swivel disposed between the case back and the C-clamp whereby the case back can pivot about the C-clamp;
a reversible ratchet mechanism within the swivel, whereby the relative pivotal position of the case back to the C-clamp is selectively held;
a cross handle in a top of the ratchet for reversing the ratchet;
the C-clamp attached to a side of the swivel, the C-clamp attached at a vertical portion of the C-clamp;
the back side of the case back attached to a side of the swivel opposite the C-clamp;
a lower horizontal portion of the C-clamp emanating from the vertical portion of the C-clamp, the lower horizontal portion terminating in a lower planar surface, the lower planar surface for contacting a surface of a chosen support;
an upper horizontal portion of the C-clamp emanating from the upper horizontal portion of the C-clamp, the upper horizontal portion terminating in a threaded aperture,;
a threaded rod inserted within the aperture, the threaded rod having an upper planar surface for contacting a surface of the chosen support opposite that of the lower planar surface;
a rod swivel between the upper planar surface and the threaded rod, the rod swivel providing for use of the C-clamp on an imperfect surface;
a handle receiver at an upper boundary of the threaded rod;
a T-handle slideably engaged within a handle receiver, the T-handle for rotating the threaded rod, thereby causing tightening and loosening of the planar surfaces about the chosen support.

18. The invention in claim 17 wherein the cage members are rubber coated.

19. The invention in claim 18 wherein the base plate is porous.

20. The invention in claim 19 wherein the case back is porous.
